(19) United States
(12) Patent Application Publication
(10) Pub. No.: US 2017/0038008 A1
(43) Pub. Date: Feb. 9, 2017

(54) COLD UTILIZATION SYSTEM, ENERGY SYSTEM COMPRISING COLD UTILIZATION SYSTEM, AND METHOD FOR UTILIZING COLD UTILIZATION SYSTEM

(71) Applicant: Masashi TADA, Nagoya-shi (JP)

(72) Inventor: Masashi TADA, Nagoya-shi (JP)

(21) Appl. No.: 15/296,849

(22) Filed: Oct. 18, 2016

Related U.S. Application Data
(63) Continuation of application No. PCT/JP2015/061508, filed on Apr. 14, 2015.

(30) Foreign Application Priority Data
Apr. 19, 2014 (JP) 2014-098091

(51) Int. Cl. F17C 9/04; F02C 1/02; F01K 25/10

(52) U.S. Cl. CPC F17C 9/04; F01K 25/10; F02C 1/02

(57) ABSTRACT

A cold energy power generation system increases the efficiency in utilizing the cold exergy of liquefied gas while freely controlling the gas supply pressure on the outlet side of a secondary expansion turbine. The system includes a pressure-increasing pump for increasing the pressure of a low-temperature liquefied gas to a pre-overboost pressure while maintaining the liquid gas in a liquid state, a Rankine-cycle-type primary power generation apparatus, a heater for heating a vaporized gas, and a direct-expansion-type secondary power generation apparatus. Since the cold exergy of the liquefied gas is more efficiently utilized as pressure exergy than as temperature exergy, the system converts the cold exergy more preferentially to pressure exergy, and the optimal operating conditions that maximize the conversion efficiency can be determined by the composition of the liquefied gas, the temperature of the heating source, and the gas supply pressure.

### CLAIM OF PRIORITY

This application is a Continuation of International Patent Application No. PCT/JP2015/061508, filed on Apr. 14, 2015, which claims priority to Japanese Patent Application No. 2014-098091, filed on Apr. 19, 2014, each of which is hereby incorporated by reference.

### BACKGROUND OF THE INVENTION

1. Field of the Invention

The present invention relates to a cold utilization system which utilizes cold of a low-temperature liquefied gas stored in a storage tank, to an energy system including the cold utilization system, and to a method for utilizing the cold utilization system.

2. Description of the Related Art

An example of a known low-temperature liquefied gas is liquefied natural gas (LNG). Natural gas (NG) produced at a production site in a foreign country is cooled and liquefied through use of electric power, thereby producing liquefied natural gas. Liquefied natural gas having a reduced volume is imported by an LNG transport tanker. In general, liquefied natural gas is vaporized through use of an open rack vaporizer or the like in a country into which the liquefied natural gas is imported. At that time, as a result of heat exchange between the liquefied natural gas and seawater, the cold energy of the liquefied natural gas is discarded into the seawater. FIG. 15 shows the estimated status of utilization of cold of liquefied natural gas imported to Japan in one year. Most of the cold energy is not recovered and is discarded without being utilized.

There has been known a cold utilization system which utilizes the cold energy of liquefied natural gas for efficient use of the cold energy. Specifically, an example of such a known cold utilization system is a cold energy power generation system. Existing cold energy power generation systems include a Rankine-cycle-type cold energy power generation system, a direct-expansion-type cold energy power generation system, and a combined-type cold energy power generation system in which the Rankine cycle and direct expansion are employed.

In the Rankine-cycle-type cold energy power generation system, a working fluid (intermediate medium) such as hydro carbon or chlorofluorocarbon is condensed in a condenser through use of cold of liquefied natural gas, and the condensed working fluid is vaporized in a vaporizer. A turbine is driven by the vaporized working fluid, whereby electric power is generated. In the direct-expansion-type cold energy power generation system, liquefied natural gas is vaporized in a vaporizer, and a turbine is driven by the vaporized natural gas, whereby electric power is generated.

Meanwhile, in the combined-type cold energy power generation system, the Rankine-cycle-type cold energy power generation system and the direct-expansion-type cold energy power generation system are combined as shown in, for example, Japanese Patent Application Laid-Open (kokai) Nos. H9-151707 and H5-302504. As compared with the cold energy power generation systems in which the Rankine-cycle-type cold energy power generation system or the direct-expansion-type cold energy power generation system is used solely, the combined-type cold energy power generation system is higher in recovery rate of available cold energy (cold exergy) of liquefied natural gas and higher in electric power generation performance.

### BRIEF DESCRIPTION OF THE INVENTION

In the combined-type cold energy power generation system, the cold exergy (available cold energy) of liquefied natural gas is used as temperature exergy for condensing a working fluid that circulates through the Rankine cycle and as pressure exergy for driving a direct-expansion-type turbine by natural gas vaporized as result of heat exchange with the working fluid.

When a portion of the cold exergy of liquefied natural gas used as gas supply pressure exergy increases, as shown in FIG. 16, the remaining cold exergy that can be utilized decreases. Notably, FIG. 16 shows the utilizable portion of the cold exergy at each LNG import terminal for the case where a conventional cold utilization system is used.

Therefore, in the case where the gas supply pressure required by a gas supply destination is high, the pressure exergy that can be utilized by the direct-expansion-type turbine decreases, and the amount of generated electric power decreases. FIGS. 17 and 18 show the performances of cold energy power generation systems. Specifically, FIG. 17 is a list of the performances of cold energy power generation systems, and FIGS. 18A, 18B, and 18C are a set of graphs each showing the relation between the gas supply pressure and power generation per unit amount of gas in FIG. 17. FIGS. 17 and 18 show the trend in which the higher the gas supply pressure, the lower the power generation per unit amount of gas.

Particularly in recent years, as a result of wide use of gas turbine combined-cycle power generation in the electric power industry and an increase in the amount of gas supply in the gas industry, the pressure for gas supply has increased. Therefore, the ratio of a portion of the cold exergy of liquefied natural gas to all the cold exergy, which portion is converted to the pressure exergy of the supply gas, tends to increase, and the remaining portion of the cold exergy that can be converted to electric power in a cold energy power generation system tends to decrease. As a result, the amount of electric power generated by the cold energy power generation system tends to decrease, and therefore, the cold energy power generation system has not come into wide use.

Not only the cold energy power generation system, but also other systems in which cold is utilized may similarly suffer the problem that the pressure exergy of gas that can be utilized for the direct-expansion-type turbine decreases when the gas supply pressure required by a gas supply destination is high. Also, this problem may similarly arise in cold utilization systems in which low-temperature liquefied gases other than liquefied natural gas are used.

A main object of the present invention is to provide a cold utilization system that can increase the utilization efficiency of the cold exergy of liquefied gas while freely setting and controlling the gas supply pressure on the outlet side of the direct-expansion-type turbine, and to provide optimal operating conditions for the cold utilization system.

A cold energy power generation system comprises (a) a pressure-increasing pump that is configured to increase the pressure of a low-temperature liquefied gas stored in a storage tank to a predetermined (pre-overboost) pressure while maintaining the liquefied gas in a liquid state, (b) a primary power generation apparatus which generates electric power through use of the cooled cold exchange object, including a vaporizer that is configured to exchange heat between a predetermined cold exchange object and the liquefied gas whose pressure has been increased by the pressure-increasing pump, to thereby cool the cold exchange object and vaporize the liquefied gas, (c) a heater for heating the vaporized gas flowing out of the vaporizer to thereby increase the temperature of the vaporized gas, and (d) a direct-expansion-type secondary power generation apparatus which includes a secondary turbine that is configured to be driven by a vaporized gas produced as a result of vaporization of the liquefied gas by the vaporizer, where the temperature of the vaporized gas has been increased by the heater, and which generates electric power when the secondary turbine is driven.

The cold energy power generation system is characterized in that on a Mollier diagram of a gas to be stored in the storage tank, a point which determines the pressure and the temperature of the gas in a state in which the gas is stored in the storage tank is defined as a process start point (C1); on the Mollier diagram, a point which determines the predetermined (pre-overboost) pressure and the temperature of the gas on the inlet side of the vaporizer is defined as a pre-overboost point (C2); on the Mollier diagram, an operating point that determines the pressure and the temperature of the gas on the inlet side of the secondary turbine is defined as a turbine inlet point (C3); on the Mollier diagram, the turbine inlet point or an operation point (CA) that determines the pressure and the temperature of the gas on the outlet side of the vaporizer is defined as an intermediate point, on the Mollier diagram, a point which determines the pressure and the temperature of the gas on the outlet side of the secondary turbine is defined as a turbine outlet point (C4), a value obtained by subtracting the enthalpy at the process start point from the enthalpy at the pre-overboost point is defined as a first enthalpy difference (first work) (Δh1), a value obtained by subtracting the enthalpy at the pre-overboost point from the enthalpy at the intermediate point is defined as a second enthalpy difference (second work) (Δh2; Δh2rank), work which is performed by the secondary turbine when the state of the gas changes from a state at the turbine inlet point (C3) which determines the pressure and the temperature of the gas on the inlet side of the secondary turbine to a state at the turbine outlet point is defined as a third enthalpy difference (third work) (Δh3), a value obtained by subtracting the first enthalpy difference (first work) from the sum of the second enthalpy difference (second work) and the third enthalpy difference (third work) or a value obtained by subtracting the first enthalpy difference (first work) from the sum of the third enthalpy difference (third work) and the product of the second enthalpy difference (second work) and an efficiency coefficient which is greater than 0 but less than a theoretical thermal efficiency of the Carnot cycle determined by the temperatures at the pre-overboost point and the intermediate point is defined as a total enthalpy difference (Δhtotal), and the predetermined (pre-overboost) pressure is set on the basis of a value (Δhtotal) obtained by subtracting the first work from the sum of the second work and the third work.

In the present invention, the pressure of the low-temperature liquefied gas stored in the storage tank is increased to the predetermined (pre-overboost) pressure by the pressure-increasing pump such that the liquefied gas remains in a liquid state. In the vaporizer of the primary power generation apparatus, heat is exchanged between the liquefied gas whose pressure has been increased by the pressure-increasing pump and the predetermined cold exchange object (intermediate medium). As a result, the cold exchange object is cooled, and the liquefied gas is vaporized and becomes a vaporized gas. The secondary turbine of the direct-expansion-type secondary power generation apparatus is driven by the vaporized gas flowing out of the vaporizer. In this manner, the cold exergy of the low-temperature liquefied gas stored in the storage tank is used as temperature exergy for cooling the cold exchange object at the primary power generation apparatus and as pressure exergy for driving the turbine at the direct-expansion-type secondary power generation apparatus.

The inventor of the present application gained the knowledge that it is effective to use the total enthalpy difference based on the above-mentioned first, second, and third enthalpy differences so as to grasp the efficiency of utilization of the cold exergy of liquefied gas. Specifically, the total enthalpy difference shows that the greater the value of the total enthalpy difference, the higher the efficiency of utilization of the cold exergy of liquefied gas. The inventor found that the total enthalpy difference depends on the gas pressure at the pre-overboost point and that the cold exergy utilization efficiency can be increased by using, as the predetermined (pre-overboost) pressure, the pressure at the pre-overboost point corresponding to the total enthalpy difference at which the cold exergy utilization efficiency becomes high. In view of this, in the present invention, the predetermined (pre-overboost) pressure is set on the basis of the total enthalpy difference, whereby the cold exergy utilization efficiency can be increased.

When the pressure of liquefied gas is increased by the pressure-increasing pump, the gas supply pressure on the outlet side of the secondary turbine increases. In the present invention, since the pressure of liquefied gas is increased (pre-overboost) by the pressure-increasing pump, the gas supply pressure on the outlet side of the secondary turbine can be freely set and controlled.

The cold energy power generation system of the present invention can be embodied, for example, as follows. Specifically, the cold energy power generation system comprises a pressure-increasing pump that increases the pressure of a low-temperature liquefied gas stored in a storage tank to a predetermined (pre-overboost) pressure equal to or higher than the critical pressure of the gas while maintaining the liquefied gas in a liquid state; a primary power generation apparatus which generates electric power through use of the cooled cold exchange object, including a vaporizer that exchanges heat between a predetermined cold exchange object (intermediate medium) and the liquefied gas whose pressure has been increased by the pressure-increasing pump, while maintaining the pressure of the liquefied gas at a pressure equal to or higher than the critical pressure, to thereby cool the cold exchange object and vaporize the liquefied gas; and a direct-expansion-type secondary power generation apparatus which includes a secondary turbine that is driven by a vaporized gas produced as a result of vaporization of the liquefied gas by the vaporizer, where the temperature of the vaporized gas has been increased by the heater, and which generates electric power when the secondary turbine is driven.

In the above-described configuration, the process of vaporizing the liquefied gas in the vaporizer while maintaining the pressure of the liquefied gas at a pressure equal to or higher than the critical pressure of the gas is adapted to efficiently utilize the cold exergy of the liquefied gas. Specifically, the greater the difference between the enthalpy of the liquefied gas at the inlet of the vaporization process (C2) and the enthalpy of the vaporized gas at the outlet of the vaporization process (C3 or CA), the higher the ratio of a portion of the cold exergy of the liquefied gas to all the cold exergy, which portion is converted to temperature exergy used by the primary power generation apparatus. The recovery of cold exergy through use of the vaporizer of the primary power generation apparatus involves heat transfer. The rate of recovery of cold exergy accompanied by heat transfer is lower than the efficiency of recovering cold exergy by driving the secondary turbine through use of the pressure exergy of the gas. Therefore, when the ratio of a portion of the cold exergy of the liquefied gas to all the cold exergy, which portion is converted to temperature exergy used by the primary power generation apparatus, increases, the cold exergy utilization efficiency decreases.

When the pressure of liquefied gas is increased to a pressure equal to or higher than the critical pressure, the difference (so-called latent heat of vaporization) between the enthalpy of liquefied gas after the inlet of the vaporization process (for example, the enthalpy at a boiling curve on the Mollier diagram) and the enthalpy of vaporized gas at the outlet of the vaporization process (for example, the enthalpy at a condensing curve on the Mollier diagram) decreases. As a result, although the cold exergy converted to temperature exergy at the primary power generation apparatus decreases, the cold exergy converted to pressure exergy at the direct-expansion-type secondary power generation apparatus increases. Accordingly, in the present invention in which heat exchange is performed at the vaporizer while the pressure of liquefied gas is maintained at a pressure equal to or higher than the critical pressure, the efficiency of utilizing the cold exergy of liquefied gas can be increased when the cold energy power generation system is considered as a whole.

### BRIEF DESCRIPTION OF THE DRAWINGS

FIG. 1 is a diagram schematically showing a cold energy power generation system.

FIG. 2 is a diagram showing the outline of a cold energy power generation process on a Mollier diagram.

FIG. 3 is a table showing an example of calculation of various parameters of natural gas by REFPROP.

FIGS. 4A, 4B, and 4C show the results of calculation of a first enthalpy difference (first work) Δh1, a second enthalpy difference (second work) Δh2, and a third enthalpy difference (third work) Δh3, respectively, for the case where the temperature (T3) at the inlet of a secondary expansion turbine is 20° C.

FIG. 5 shows the result of calculation of “Δh2+Δh3−Δh1” of expression (1) for the case where the temperature (T3) at the inlet of the secondary expansion turbine is 20° C.

FIGS. 6A, 6B, and 6C show the results of calculation of the first enthalpy difference (first work) Δh1, the second enthalpy difference (second work) Δh2, and the third enthalpy difference (third work) Δh3, respectively, for the case where the temperature (T3) at the inlet of the secondary expansion turbine is 50° C.

FIG. 7 shows the result of calculation of “Δh2+Δh3−Δh1” of expression (1) for the case where the temperature (T3) at the inlet of the secondary expansion turbine is 50° C.

FIG. 8 shows the result of calculation of “Δ×Δh2+Δh3−Δh1” of expression (3) for the case where the temperature (T3) at the inlet of the secondary expansion turbine is 20° C.

FIG. 9 shows the result of calculation of “Δ×Δh2+Δh3−Δh1” of expression (3) for the case where the temperature (T3) at the inlet of the secondary expansion turbine is 50° C.

FIG. 10 is a diagram showing a cold energy power generation process and a natural gas liquefying process on the Mollier diagram, the cold energy power generation process using liquefied natural gas.

FIG. 11 is a Mollier diagram used for describing the definition of a second enthalpy difference Δh2rank in a second embodiment.

FIG. 12 shows the result of calculation of “Δ×Δh2rank+Δh3−Δh1” of expression (4) in the second embodiment for the case where the temperature (T3) at the inlet of the secondary expansion turbine is 20° C.

FIG. 13 shows the result of calculation of “Δ×Δh2rank+Δh3−Δh1” of expression (4) in the second embodiment for the case where the temperature (T3) at the inlet of the secondary expansion turbine is 50° C.

FIG. 14 is a graph showing an example of the result of a trial calculation for determining the relation between gas supply pressure and power generation amount through use of the expression (4) (“Δ×Δh2rank+Δh3−Δh1”).

FIG. 15 is an illustration showing the estimated status of utilization of cold of liquefied natural gas imported to Japan in one year.

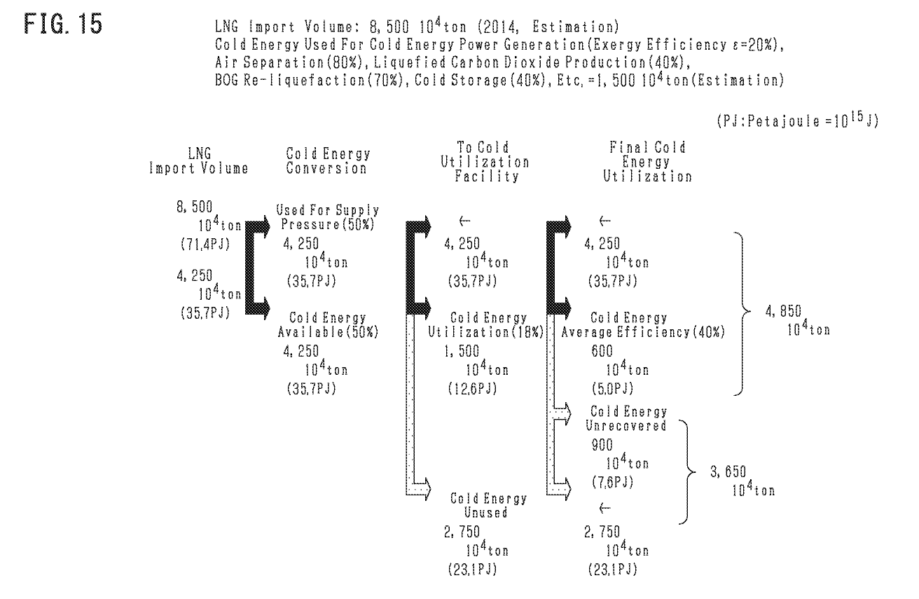

FIG. 16 is an illustration cited from the materials of Research Council for Energy and Information Technology and exemplifying the utilizable portion of cold exergy at each LNG import terminal for the case where a conventional cold utilization system is used.

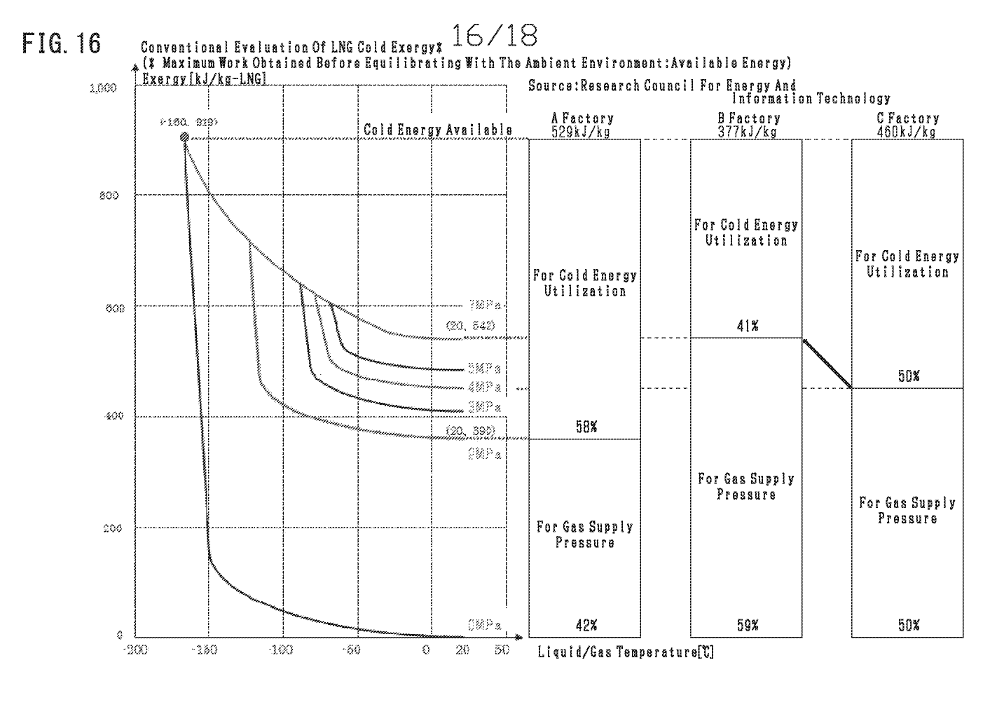

FIG. 17 is a table showing a list of performances of cold energy power generation systems.

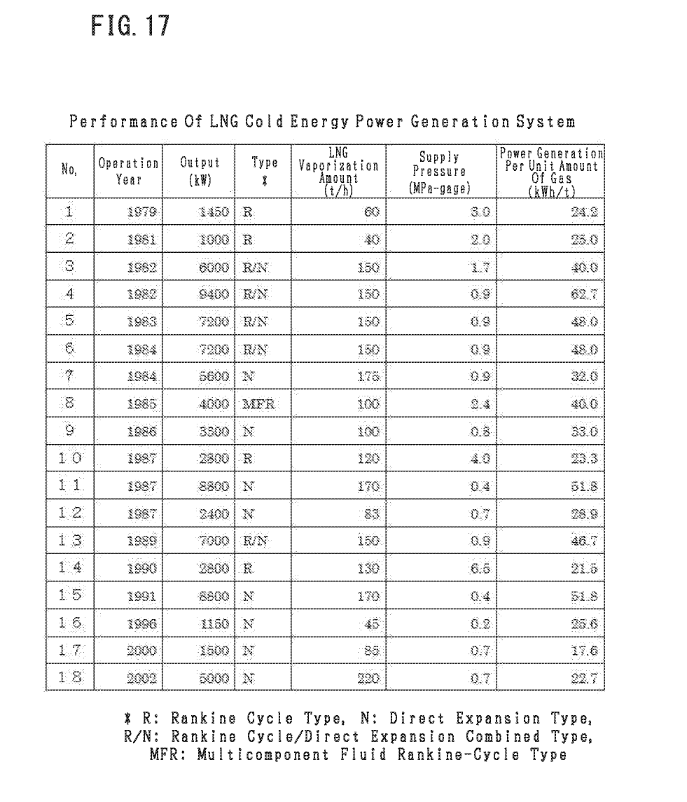

FIGS. 18A, 18B, and 18C are a set of graphs each showing the relation between gas supply pressure and power generation per unit of a cold energy power generation system.

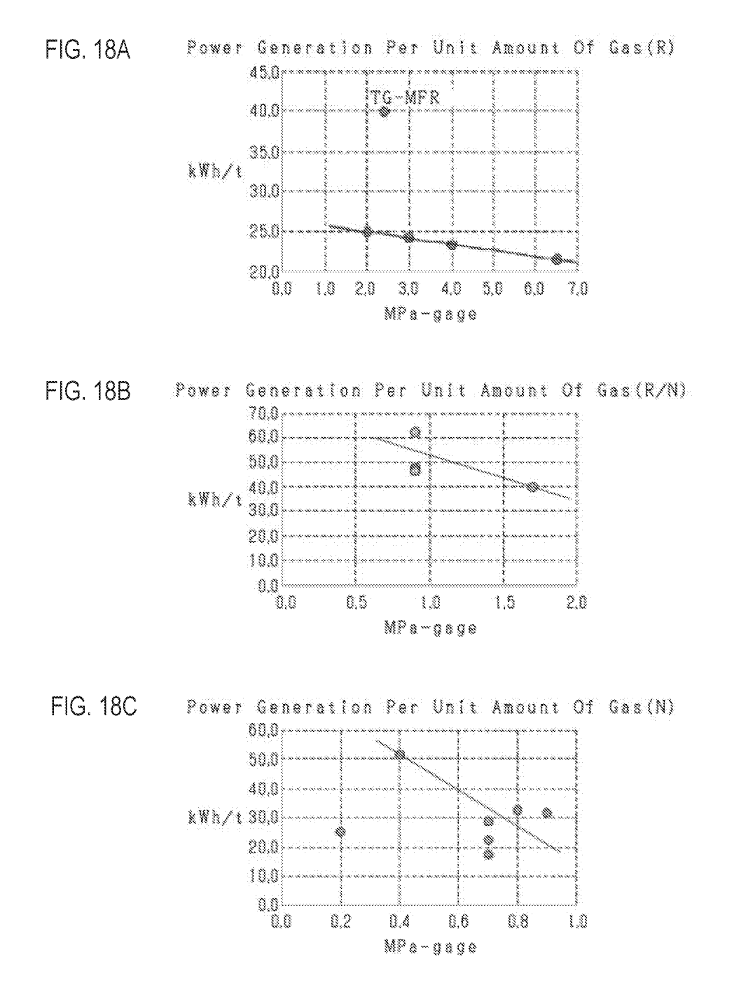

### DETAILED DESCRIPTION OF EMBODIMENTS OF THE INVENTION

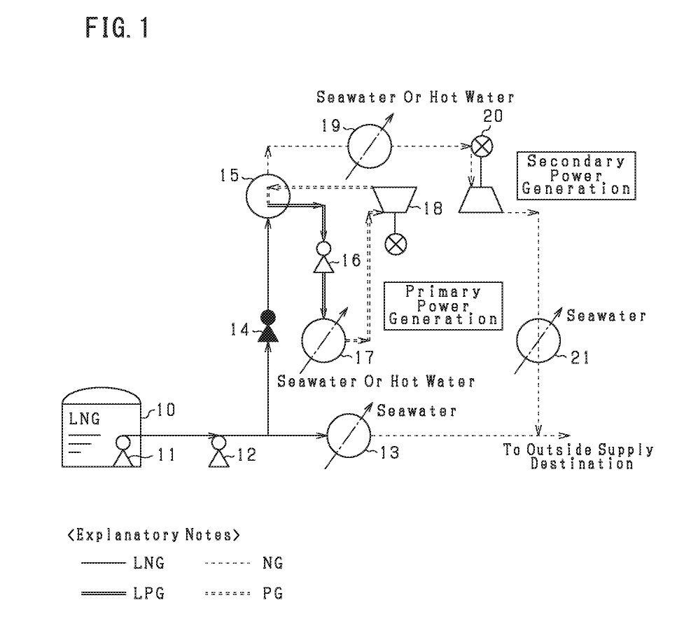

One embodiment in which the present invention is embodied as a cold energy power generation system will now be described with reference to the drawings. First, the overall configuration of a cold energy power generation system will be described with reference to FIG. 1. The cold energy power generation system generates electric power by utilizing the cold of liquefied natural gas (LNG) stored in a storage tank 10. In the present embodiment, there is shown an example in which the cold energy power generation system is applied to a vaporization apparatus that vaporizes the liquefied natural gas stored in the storage tank 10 and supplies it to the outside as a natural gas (NG).

As shown in FIG. 1, the liquefied natural gas stored in the storage tank 10 is increased in pressure by a primary pump 11 and is supplied to a secondary pump 12. The pressure of the supplied liquefied natural gas is increased further by the secondary pump 12. The liquefied natural gas whose pressure has been increased by the secondary pump 12 is supplied to a first vaporizer 13 and a tertiary pump 14. The first vaporizer 13 heats and vaporizes the liquefied natural gas through heat exchange between the liquefied natural gas supplied from the secondary pump 12 and a heating medium. In the present embodiment, an open rack vaporizer (ORV) is used as the first vaporizer 13. Also, water (seawater) of ordinary temperature is used as the heating medium for the first vaporizer 13.

The tertiary pump 14 is a pressure-increasing pump for increasing the pressure of the liquefied natural gas supplied from the secondary pump 12 to a pre-overboost pressure. The liquefied natural gas whose pressure has been increased by the tertiary pump 14 is supplied to a main vaporizer 15. The main vaporizer 15 vaporizes the liquefied natural gas to a natural gas through heat exchange between the supplied liquefied natural gas and a working fluid (intermediate medium) of a Rankine cycle. In the present embodiment, a shell and tube vaporizer (STV) is used as the main vaporizer 15. Notably, in the present embodiment, petroleum gas (PG) is used as the working fluid (intermediate medium).

The main vaporizer 15 constitutes a Rankine-cycle-type primary power generation apparatus. The primary power generation apparatus includes a circulation pump 16, an intermediate medium evaporator 17, and a primary turbine generator 18, as well as the main vaporizer 15. In the primary power generation apparatus, the main vaporizer 15 functions as a condenser that cools the working fluid circulating through the Rankine cycle by using the liquefied natural gas whose pressure has been increased by the tertiary pump 14, to thereby condense the working fluid.

The working fluid (intermediate medium) condensed at the main vaporizer 15 is supplied to the intermediate medium evaporator 17 by the circulation pump 16. The intermediate medium evaporator 17 vaporizes the working fluid through heat exchange between the low-temperature working fluid and a heating medium. In the present embodiment, an STV is used as the intermediate medium evaporator 17, and water (seawater) of ordinary temperature or hot water which is higher in temperature than the water of ordinary temperature is used as the heating medium for the intermediate medium evaporator 17. For example, the hot water is produced through use of the energy of waste heat from a plant in a neighboring area. The working fluid vaporized at the intermediate medium evaporator 17 flows into the primary expansion turbine of the primary turbine generator 18 and drives the primary expansion turbine. As a result of the drive of the primary expansion turbine, the generator of the primary turbine generator 18 generates electric power. As described above, the cold exergy of the liquefied natural gas stored in the storage tank 10 is used as temperature exergy, whereby the primary power generation apparatus generates electric power.

The natural gas flowing out of the main vaporizer 15 is supplied to a first heater 19. The first heater 19 heats the natural gas to a higher temperature through heat exchange between the supplied natural gas and a heating medium. For example, water (seawater) of ordinary temperature or hot water can be used as the heating medium for the first heater 19. The natural gas heated at the first heater 19 flows into the secondary expansion turbine of a secondary turbine generator 20 and drives the second expansion turbine. As a result of the drive of the secondary expansion turbine, the generator of the secondary turbine generator 20 generates electric power. As described above, the cold exergy of the liquefied natural gas is used as pressure exergy, whereby the direction-expansion-type secondary power generation apparatus generates electric power. Notably, although FIG. 1 shows a structure that includes a single secondary expansion turbine. However, the structure of the secondary turbine generator 20 is not limited to that structure. For example, the secondary turbine generator 20 may have a multi-stage expansion structure in which secondary expansion turbines and heaters for re-heating the gas flowing out of the respective secondary expansion turbines are connected alternatingly.

The natural gas flowing out of the secondary expansion turbine of the secondary turbine generator 20 is supplied to a second heater 21. The second heater 21 heats the natural gas to a higher temperature through heat exchange between the natural gas and a heating medium. For example, water (seawater) of ordinary temperature can be used as the heating medium for the second heater 21. The natural gas heated at the second heater 21 and the natural gas vaporized at the first vaporizer 13 are merged into a single flow of natural gas, which is then fed to a gas pipe as, for example, town gas. As a result, the natural gas is supplied to an outside supply destination. Notably, the natural gas heated at the second heater 21 and the natural gas vaporized at the first vaporizer 13 may be fed to independent gas pipes without being merged.

Next, there will be described a method of setting the above-mentioned pre-overboost pressure of the liquefied natural gas whose pressure is increased by the tertiary pump 14. This setting method is based on the following expression (1), expression (3), or expression (4), depending on the embodiment.

Δhtotal=Δh2+Δh3−Δh1 (1)

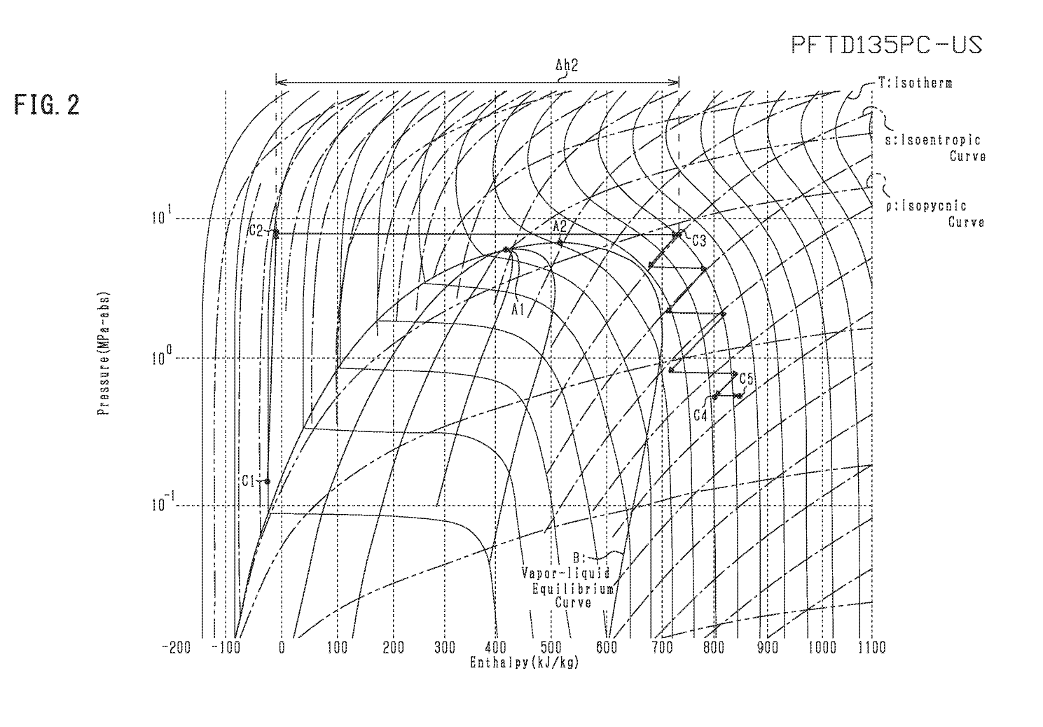

In expression (1), Δh1 denotes a first enthalpy difference (first work), Δh2 denotes a second enthalpy difference (second work), Δh3 denotes a third enthalpy difference (third work), and Δhtotal denotes a total enthalpy difference. In order to define the enthalpy differences Δh1, Δh2, and Δh3, operating points of a cold utilization process (cold energy power generation process) on the Mollier diagram shown in FIG. 2 will be first described.

In FIG. 2, a first point C1 shows the state of the liquefied natural gas stored in the storage tank 10, and a second point C2 shows the state of the liquefied natural gas having been increased in pressure by the tertiary pump 14. Also, a third point C3 shows the state of the natural gas at the inlet of the secondary expansion turbine of the secondary turbine generator 20, a fourth point C4 shows the state of the natural gas at the outlet of the secondary expansion turbine, and a fifth point C5 shows the state of the natural gas at the outlet of the second heater 21. Also, in FIG. 2, the pressure and temperature at the first point C1 will be referred to as a first pressure P1 and a first temperature T1, respectively, and the pressure at the second point C2 will be referred to as a second pressure P2. In the present embodiment, the operating point changes from the first point C1 to the second point C2 with an isenthalpic change (adiabatic compression). Also, the pressure and temperature at the third point C3 will be referred to as a third pressure P3 and a third temperature T3, respectively. In the present embodiment, the operating point changes from the second point C2 to the third point C3 with an isobaric change. Therefore, the third pressure P3 is equal to the second pressure P2.

The pressure and temperature at the fourth point C4 will be referred to as a fourth pressure P4 and a fourth temperature T4, respectively. Also, the pressure and temperature at the fifth point C5 will be referred to as a fifth pressure P5 and a fifth temperature T5, respectively. In the present embodiment, it is assumed that the fifth temperature T5 is equal to the third temperature T3. Of the change of the operating point from the third point C3 to the fourth point C4, the change of the operating point at the secondary expansion turbine occurs with an isenthalpic change (adiabatic expansion).

The first enthalpy difference (first work) Δh1 is defined as a value obtained by subtracting the specific enthalpy at the first point C1 from the specific enthalpy at the second point C2. The second enthalpy difference (second work) Δh2 is defined as a value obtained by subtracting the specific enthalpy at the second point C2 from the specific enthalpy at the third point C3.

The third enthalpy difference (third work) Δh3 is defined as a work per unit mass of the natural gas that is performed by the secondary expansion turbine in a period during which the operating point changes from the third point C3 to the fourth point C4 such that the operating point does not enter the liquid phase side of a vapor-liquid equilibrium curve B on the Mollier diagram. The condition that the operating point does not enter the liquid phase side of the vapor-liquid equilibrium curve B on the Mollier diagram is provided in order to prevent re-condensation of the gas and avoid breakage of the secondary expansion turbine due to erosion or cavitation damage. In the present embodiment, multi-stage expansion is performed in order to satisfy the above-described condition. In the multi-stage expansion, adiabatic expansion by the secondary expansion turbine and re-heating of the expanded gas are repeated alternatingly in accordance with the set values of the third pressure P3 and the third temperature T3 at the third point C3. FIG. 2 shows an example in which four-stage expansion is performed. In the present embodiment, for the re-heating during the multi-stage expansion, for example, the above-described hot water is used as a heating medium, and the natural gas is assumed to be heated to the third temperature T3 with an isobaric change.

The reason for using the above-mentioned expression (1) is that the thermal energy absorption process in the vaporization process (the step of vaporization at the main vaporizer 15) in which the liquefied gas is heated is evaluated as an effect (merit); i.e., an energy is added by the thermal energy absorption process. In contrast to the present system, in supercritical pressure power generation performed through use of water vapor, the process of heating and vaporizing water is considered as loss of the thermal energy of fuel. Therefore, for the supercritical pressure power generation, “Δh3−Δh2−Δh1” is used instead of the above-described expression (1). Accordingly, the sign of Δh2 in the supercritical pressure power generation performed through use of water vapor is opposite the sign of Δh2 in the above-described expression (1). This is because of the relation of the temperature of an object and the temperature of the environment; namely, where as liquefied gas of very low temperature vaporizes due to the thermal energy of the environmental temperature without addition of fuel, water vapor is produced by vaporizing water by heating the water using fuel; i.e., increasing the temperature of water from the environmental temperature to a predetermined temperature.

Next, the cold energy of the liquefied gas is converted to temperature energy and pressure energy as follows:

Cold energy=temperature energy+pressure energy (2)

When the available energy (exergy) recovery rates of the temperature energy and the pressure energy obtained through the conversion are compared, the temperature exergy recovery rate is lower than the pressure exergy recovery rate because the temperature exergy recovery rate is restricted by the second law of thermodynamics (Carnot efficiency). In view of this, in order to increase the cold exergy recovery rate, it is effective to convert the cold energy to pressure energy rather than temperature energy. Namely, a method of converting the cold energy more preferentially to pressure energy is effective.

A proper method for converting the cold energy more preferentially to pressure energy is a method for vaporizing liquefied gas in a state in which the liquefied gas has been pressurized to a high pressure. The Mollier diagram for liquefied gas shows that the higher the pressure under which the liquefied gas is vaporized, the smaller the latent heat of vaporization of the liquefied gas and the smaller the enthalpy difference in the vaporization process. However, the pressure exergy of the vaporized gas increases.

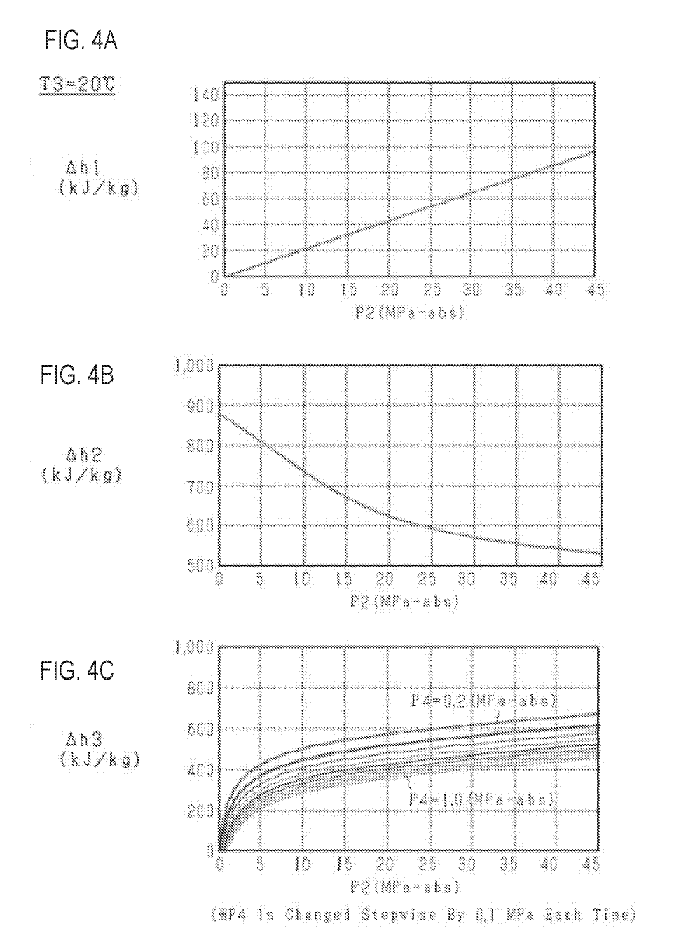

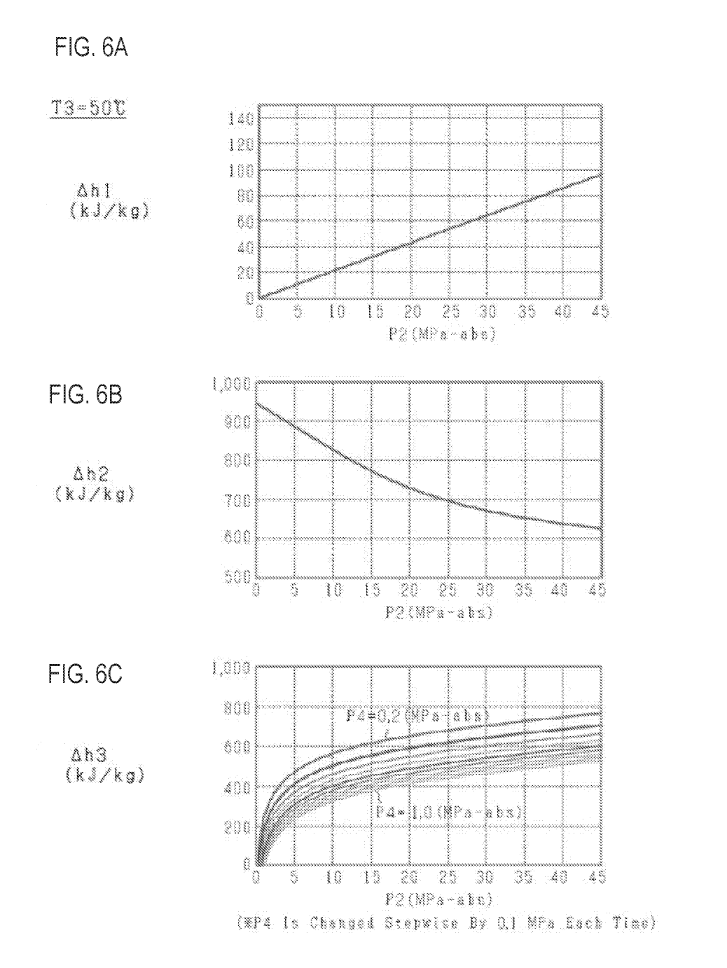

When the pressure increases to a pressure equal to or higher than the critical pressure of the liquefied gas and exceeds the cricondenbar under which evaporation or condensation occurs even when the pressure is equal to or higher than the critical pressure, the latent heat of vaporization becomes zero. Also, as shown in FIG. 4A and FIG. 6B, the enthalpy difference Δh2 in the vaporization process decreases as the pressure increases. Accordingly, when the liquefied gas is vaporized under the supercritical pressure, a larger amount of cold energy can be converted to pressure energy. As a result, it is possible to efficiently convert the cold energy to work (electric power) by utilizing the pressure energy that has a high exergy recovery rate.

The total enthalpy difference Δhtotal represented by the above-described expression (1) assumes the maximum value at a certain second pressure P2. The efficiency of the conversion of the cold exergy to work can be maximized by setting or using the second pressure P2 corresponding to the maximum value as a pre-overboost pressure. There will be described a method for specifying a pre-overboost pressure which maximizes the total enthalpy difference Δhtotal. In the following description, pressure is absolute pressure. Before describing the method for specifying the pre-overboost pressure, the composition and physical property values of the natural gas used in the calculation and the operating points of the cold energy power generation process will be described.

### <Composition and Physical Property Values of Natural Gas>

Mole % (Mole percent)

methane (CH4)=92%, ethane (C2H6)=4%, propane (C3H8)=3%, butane (C4H10)=1%

Mass % (Mass percent)

methane=82.61%, ethane=6.7321%, propane=7.4043%, butane=3.2531%

Molor mass

17.866 (kg/kmol)

In the present embodiment, the physical property values of natural gas having the above-mentioned composition were calculated through use of REFPROP (Version 9.1) that is a refrigerant thermophysical property database software made by National Institute of Standards and Technology (NIST) in the United States. The results of the calculations are as follows.

Critical point A1

215.85 (K), 6.8362 (MPa), 206.87 (kg/m̂3)

Cricondenbar

231.4 (K), 7.6316 (MPa), 141.58 (kg/m̂3)

Cricondentherm

247.35 (K), 4.8965 (MPa), 54.708 (kg/m̂3)

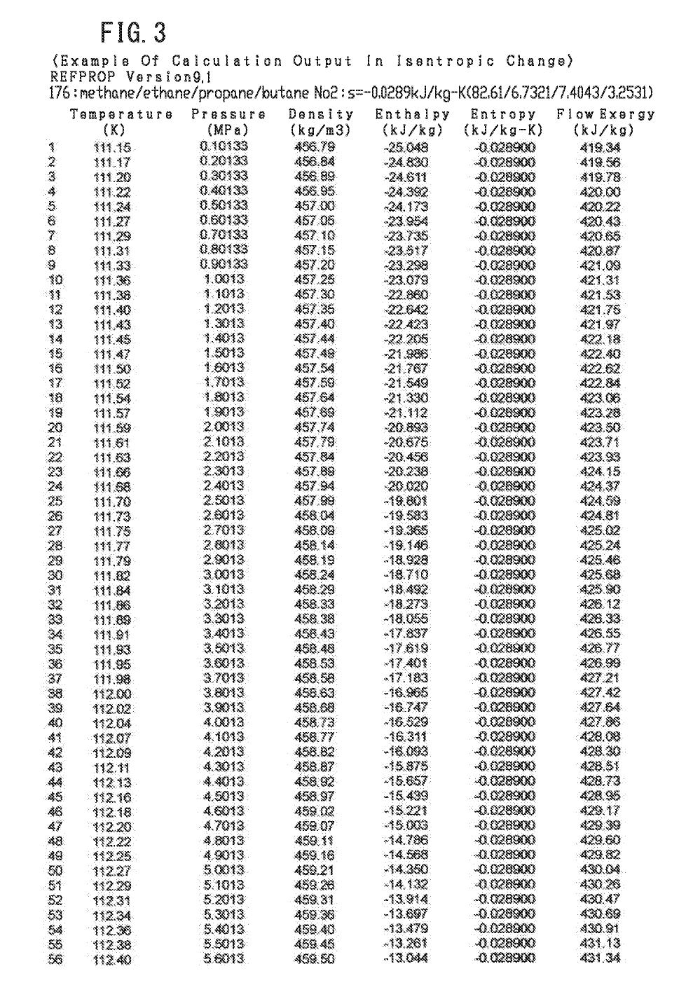

FIG. 3 shows an example in which the parameters of the natural gas in the pressure increasing process (isentropic change) from the first point C1 to the second point C2 were calculated through use of REFPROP.

In FIG. 2, the critical point of the natural gas is denoted by A1, and the operating point at which the pressure of the natural gas becomes the cricondenbar is denoted by A2. The calculated cold energy of the natural gas having the above-described composition that was able to be utilized when its temperature changed from −162° C. to 20° C. was 906 kJ/kg.

Next, calculation of the pre-overboost pressure will be described for the case where the third temperature T3 is set to 20° C. and the case where the third temperature T3 is set to 50° C. Notably, in the calculation, the first pressure P1 at the first point C1 was set to 0.101 MPa, and the first temperature T1 at the first point C1 was set to −162° C.

First, the case where the third temperature T3 is set to 20° C. will be described. In this case, for example, water of ordinary temperature is used as the heating mediums at the first heater 19 and the second heater 21.

The first enthalpy difference (first work) Δh1 is proportional to the second pressure P2. Therefore, as shown in FIG. 4A, the first enthalpy difference Δh1 increases with the second pressure P2. In the present embodiment, since the pressure of the liquefied natural gas is increased in the liquid state, the transition line of the operating point from the first point C1 to the second point C2 becomes approximately parallel to an isentropic curve (shown by a dash-dot line in FIG. 2). Therefore, the pressure of the liquefied natural gas can be increased to a higher pressure with a small enthalpy difference.

As shown in FIG. 4B, the second enthalpy difference (second work) Δh2 decreases as the second pressure P2 increases. This is because the higher the second pressure P2, the larger the specific enthalpy at the second point C2. The Mollier diagram shows that when the gas pressure becomes equal to or higher than the critical pressure, the specific enthalpy at the third point C3 starts to increase in the vicinity of 42 MPa. Meanwhile, as the gas pressure increases, the specific enthalpy at the second point C2 also increases constantly. Therefore, as shown in FIG. 4B, the second enthalpy difference Δh2 decreases constantly.

As shown in FIG. 4C, the third enthalpy difference (third work) Δh3 increases with the second pressure P2. This is because the higher the second pressure P2, the greater the degree to which the density of the gas flowing into the secondary expansion turbine increases. In particular, the gradient of an increase in the third enthalpy difference Δh3 due to an increase in the second pressure P2 to a pressure near the critical pressure is larger than that in the case where the second pressure P2 becomes higher than the critical pressure. Also, the third enthalpy difference Δh3 increases as the fourth pressure P4 decreases. This is because the lower the pressure at the outlet of the secondary expansion turbine, the greater the amount of work performed by the secondary expansion turbine. FIG. 4C shows the third enthalpy difference Δh3 calculated for different values of the fourth pressure P4 that was changed stepwise (by 0.1 MPa each time) within a range of 0.2 to 1.0 MPa. Notably, as the second pressure P2 is increased, the third enthalpy difference Δh3 becomes approximately equal to the sum of the second enthalpy difference Δh2 and the first enthalpy difference Δh1 (Δh3≅Δh1+Δh2).

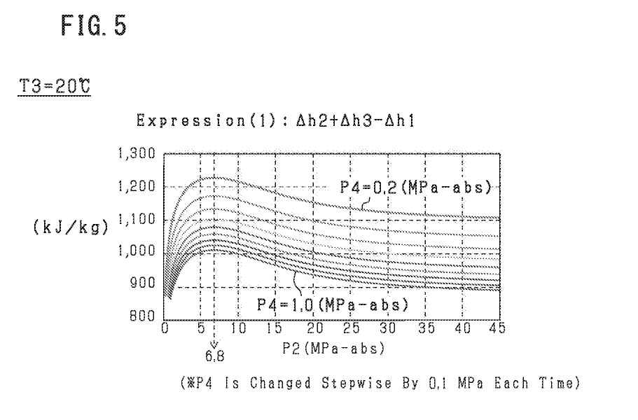

FIG. 5 shows the relation between the second pressure P2 and the total enthalpy difference Δhtotal that was calculated by substituting the first, second, and third enthalpy differences Δh1, Δh2, Δh3, calculated by the above-described method, into the above-described expression (1). As shown in FIG. 5, the second pressure P2 that exhibits the highest conversion efficiency is determined by the total enthalpy difference Δhtotal. In the calculation example for the case where the third temperature T3 is 20° C., the second pressure P2 that maximizes the total enthalpy difference Δhtotal was determined to be 6.8 MPa which is approximately equal to the critical pressure. In other words, the second pressure P2 at which the total enthalpy difference Δhtotal first became the maximum when the second pressure P2 was increased was determined to be 6.8 MPa. The second pressure P2 that exhibits the highest conversion efficiency does not change even when the gas pressure at the fourth point C4 (equal to the gas supply pressure at the fifth point C5) is changed. Notably, FIG. 5 shows the total enthalpy difference Δhtotal calculated for different values of the fourth pressure P4 that was changed stepwise (by 0.1 MPa each time) within a range of 0.2 to 1.0 MPa.

Notably, in the present calculation, the value of the third enthalpy difference Δh3 is the exergy amount (flow exergy) at the third point C3 calculated with the fifth point C5 used as a reference point. Since exergy is not a conserved quantity, in general, it cannot be equally handled as the energy amount of state change. However, since the total amount of energies at specific process points is obtained in the above-described expression (1), no problem occurs.

Subsequently, the case where the third temperature T3 is set to 50° C. will be described. In this case, for example, hot water produced through use of the energy of waste heat is used as the heating medium for the first heater 19, and, for example, water (seawater) of ordinary temperature is used as the heating medium for the second heater 21.

As shown in FIG. 6A, the first enthalpy difference (first work) Δh1 increases with the second pressure P2. Since the first enthalpy difference Δh1 is determined by the specific enthalpies at the first point C1 and the second point C2, the calculation results of FIG. 6A are identical with the calculation results of FIG. 4A described above.

As shown in FIG. 6B, the second enthalpy difference (second work) Δh2 decreases as the second pressure P2 increases. As shown in FIG. 6C, the third enthalpy difference (third work) Δh3 increases with the second pressure P2.

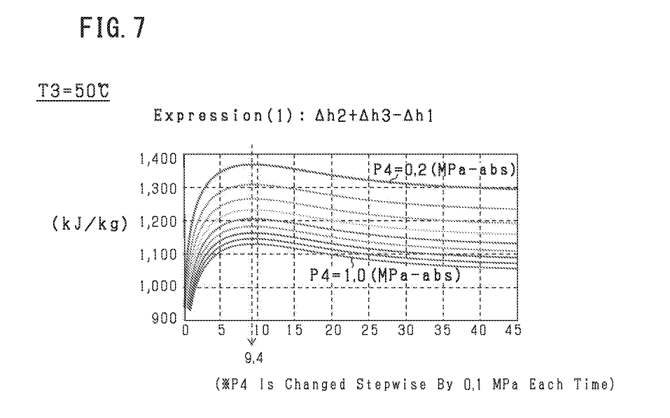

FIG. 7 shows the relation between the second pressure P2 and the total enthalpy difference Δhtotal that was calculated by substituting the first, second, and third enthalpy differences Δh1, Δh2, Δh3, calculated by the above-described method, into the above-described expression (1). As shown in FIG. 7, the second pressure P2 that exhibits the highest conversion efficiency is determined by the total enthalpy difference Δhtotal. In the calculation example for the case where the third temperature T3 is 50° C., the second pressure P2 that maximizes the total enthalpy difference was determined to be 9.4 MPa which is higher than the critical pressure (and the cricondenbar). Also, the second pressure P2 that provides the highest conversion efficiency does not change even when the gas pressure at the fourth point C4 (equal to the gas supply pressure at the fifth point C5) is changed.

Accordingly, by the above-described expression (1), the pre-overboost pressure that provides the highest conversion efficiency is determined, and even when the temperature of the vaporization heat source and the gas supply pressure are changed, the pre-overboost pressure that provides the highest conversion efficiency is similarly determined.

The above-described results show that when two conditions; i.e., the composition of the liquefied gas and the temperature of the vaporization heat source, are specified, the pre-overboost pressure at which the cold exergy of the liquefied gas can be converted to work (electric power) at the highest efficiency can be determined. Also, when the final pressure at the system outlet (the vaporized gas supply pressure) is specified in addition to the two conditions mentioned above, the magnitude of the total enthalpy difference Δhtotal can be determined, and the output (generated power) of the power generation apparatus of the overall system can be determined.

Next, there will be described the following expression used for the case where the above-described expression (1) is applied to a practical system.

Δhtotal=α×Δh2+Δh3−Δh1 (3)

The above expression (3) is an expression in which the utilization of temperature exergy in the vaporization process is restricted by the efficiency of the second law of thermodynamics (Carnot efficiency). There is assumed a system that can convert temperature exergy to work through use of all the enthalpy differences of the vaporization process. A method of determining the pre-overboost pressure on the basis of the above-described expression (3) will now be described.

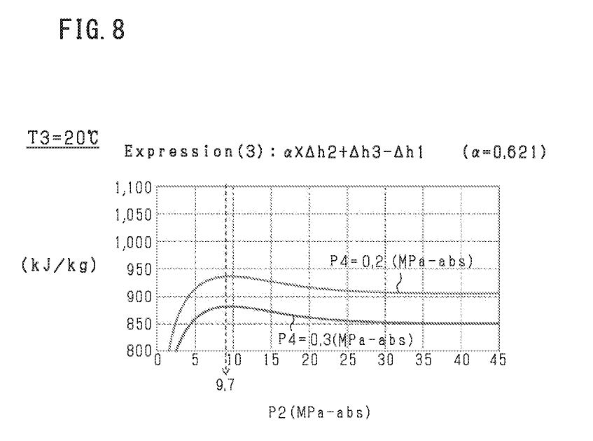

FIG. 8 shows the total enthalpy difference Δhtotal of the above-described expression (3), which was calculated on the basis of the enthalpy differences Δh1, Δh2, and Δh3 of the previously described FIGS. 4A, 4B, and 4C, respectively, and an efficiency coefficient α for the case where the third temperature T3 is 20° C. Here, the efficiency coefficient α was set to 0.621 that is the theoretical thermal efficiency of the Carnot cycle. The theoretical thermal efficiency can be calculated as follows through use of the second temperature T2 (=−162° C.) at the second point C2 and the third temperature T3 (=20° C.) at the third point C3.

$$\begin{matrix}α = 1 - T 2 / T 3 \\ = 1 - ( - 162 + 273.15 ) / ( 20 + 273.15 ) \\ = 0.621\end{matrix}$$

Notably, during the isentropic change from the first point C1 to the second point C2, the temperature of the liquefied natural gas increases although the amount of the temperature increase is very small. Therefore, with the second pressure P2, the second temperature T2 changes, and the efficiency coefficient α changes. However, in the present embodiment, in order to simplify the calculation, the temperature change of the liquefied natural gas from the first point C1 to the second point C2 is assumed to be zero for the calculation of the efficiency coefficient α.

In the case where the third temperature T3 is set to 20° C., irrespective of the fourth pressure P4, the second pressure P2 at which the total enthalpy difference becomes the maximum was calculated as 9.7 MPa which is a pressure higher than the cricondenbar. Therefore, there was obtained the result of a trial calculation which shows that, when the third temperature T3 is set to 20° C., the efficiency of conversion of cold exergy to electric power can be maximized by setting the pre-overboost pressure to 9.7 MPa.

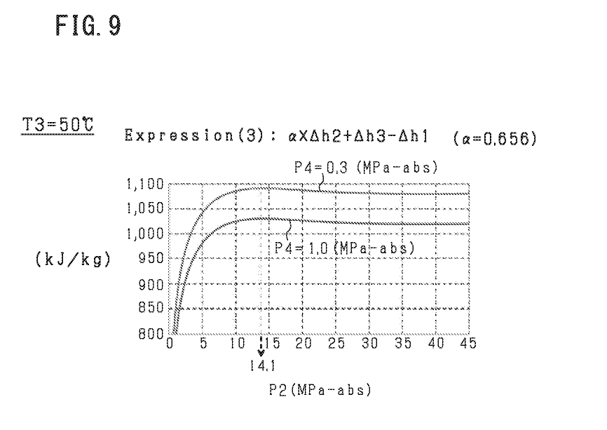

FIG. 9 shows the total enthalpy difference Δhtotal of the above-described expression (3), which was calculated on the basis of the enthalpy differences Δh1, Δh2, and Δh3 of the previously described FIGS. 4A, 4B, and 4C, respectively, and the efficiency coefficient α for the case where the third temperature T3 is 50° C. Here, the efficiency coefficient α was set to 0.656 that is the theoretical thermal efficiency of the Carnot cycle. This value can be calculated from the second temperature T2 (=−162° C.) at the second point C2 and the third temperature T3 (=50° C.) at the third point C3.

In the case where the third temperature T3 is set to 50° C., irrespective of the fourth pressure P4, the second pressure P2 at which the total enthalpy difference Δhtotal becomes the maximum was calculated as 14.1 MPa which is a pressure higher than the cricondenbar. Therefore, there was obtained the result of a trial calculation which shows that, when the third temperature T3 is set to 50° C., the efficiency of conversion of cold exergy to electric power can be maximized by setting the pre-overboost pressure to 14.1 MPa.

Since the pre-overboost pressure is set to a pressure equal to or higher than the critical pressure of natural gas, the present inventor refers to the cold energy power generation system of the present embodiment as an LNG supercritical pressure cold energy power generation system (LSG).

In this connection, when the third temperature T3 is increased, the second and third enthalpy differences Δh2 and Δh3 increase, and the temperature difference between the cold source and the heating source can be increased, whereby the theoretical thermal efficiency of the Carnot cycle can be increased. As a result, the efficiency of conversion of cold exergy to electric power in the LSG can be increased. Also, by increasing the third temperature T3, the number of stages of expansion and re-heating from the third point C3 to the fourth point C4 can be decreased, whereby the equipment cost of the LSG can be lowered.

According to the above-described present embodiment, the efficiency of conversion of cold exergy to electric power can be increased by setting the pre-overboost pressure through use of the concept of the total enthalpy difference Δhtotal. Namely, the greater the difference Δh2 between the enthalpy of liquefied natural gas at the inlet of the natural gas vaporization process (second point C2) and the enthalpy of natural gas at the outlet of the vaporization process (third point C3), the higher the ratio of a portion of the cold exergy of the liquefied natural gas to all the cold exergy, the portion being converted to temperature exergy used in the Rankine-cycle-type primary power generation apparatus. The Rankine cycle involves an irreversible process of heat transfer. Therefore, the cold exergy recovery rate (e.g., 20 to 30%) at the primary power generation apparatus is lower than the cold exergy recovery rate (e.g., 70 to 80%) at the direct-expansion-type secondary power generation apparatus. Accordingly, as can be understood from the above-described expression (2), when the ratio of a portion of the cold exergy of the liquefied natural gas to all the cold exergy, the portion being converted to temperature exergy used in the primary power generation apparatus, is increased, the efficiency of conversion of cold exergy to electric power decreases; and, when the ratio of the portion of the cold exergy converted to temperature exergy is decreased, the efficiency of conversion of cold exergy to electric power can be increased.

When the pre-overboost pressure is set to a high pressure (for example, a pressure equal to or higher than the critical pressure), the difference Δh2 between the enthalpy of liquefied natural gas at the inlet of the vaporization process of the main vaporizer 15 and the enthalpy of natural gas at the outlet of the vaporization process decreases. In this case, the latent heat of vaporization of gas in the vaporization process (the enthalpy between gas-liquid boundary lines in the Mollier diagram of FIG. 2) decreases. When the pre-overboost pressure is equal to or higher than the cricondenbar pressure, the latent heat of vaporization becomes zero. As a result, although the amount of cold exergy converted to temperature exergy decreases, the amount of cold exergy converted to pressure exergy increases. Accordingly, although the power generation amount of the Rankine-cycle-type primary power generation apparatus decreases, the power generation amount of the direct-expansion-type secondary power generation apparatus that is higher in cold exergy recovery rate (power conversion rate) than the Rankine-cycle-type power generation apparatus can be increased. As a result, taken as a whole, the cold energy power generation system can increase the efficiency of conversion of the cold exergy of liquefied natural gas to electric power.

In particular, in the case where the result of a trial calculation shows that setting the pre-overboost pressure to a pressure equal to or higher than the cricondenbar is beneficial, at the main vaporizer 15, the natural gas is vaporized while the pressure of the natural gas is maintained at a pressure equal to or higher than the cricondenbar. As a result, the efficiency of conversion of cold exergy to electric power can be increased further. Namely, liquefied natural gas that is a non-azeotropic mixture condenses even when its pressure is equal to or higher than the critical pressure if the pressure is lower than the cricondenbar. Therefore, when the pre-overboost pressure is set to a pressure equal to or higher than the cricondenbar, the liquefied natural gas is vaporized in the vaporization process without formation of a gas-liquid mixture phase. As a result, the latent heat of vaporization of the liquefied natural gas in the vaporization process becomes zero, and the latent heat of vaporization of the liquefied natural gas used for condensation of the working fluid circulating through the Rankine cycle can be decreased. Accordingly, as compared with a structure in which liquefied natural gas is vaporized with formation of a gas-liquid mixture phase, the amount of cold exergy converted to temperature exergy can be decreased further. As a result, the amount of cold exergy converted to pressure exergy can be increased, and the cold exergy-to-power conversion efficiency of the entire system can be increased further.

Also, according to the present embodiment, the higher the pre-overboost pressure (P2), the wider the range within which the fourth pressure P4 at the fourth point C4 can be set. Therefore, the pressure for supplying gas to the outside can be freely set by adjusting the secondary turbine outlet pressure.

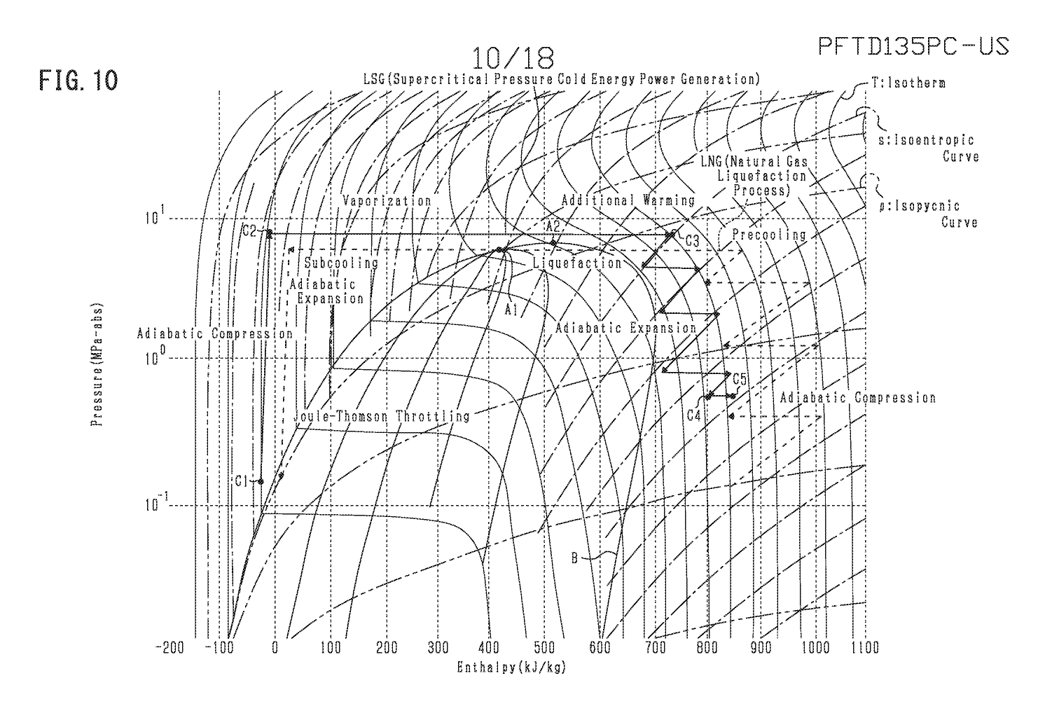

Notably, the present embodiment utilizes, in an inverse cascade manner, the cold energy of liquefied natural gas from low temperature. Namely, the present embodiment uses a process that is reversal of a natural gas liquefaction process. FIG. 10 shows a natural gas liquefaction process (LNG) together with the cold energy power generation process (LSG) of the present embodiment. In the liquefaction process, in general, natural gas is increased in pressure to a pressure near the critical pressure and is then cooled so as to avoid the gas-liquid mixing region. Therefore, the liquefaction process is composed of multi-stage compression (adiabatic compression), precooling, liquefaction, subcooling, and Joule-Thomson throttling. Also, even when the methane component ratio of the liquefied natural gas increases and results in lightening, no problem arises in the LSG. When the ratio of heavy hydrocarbons decreases, the natural gas becomes unlikely to liquefy again. Therefore, electric power can be effectively generated by the LSG.

The above-described embodiment can be implemented, for example, in the following manners.

In the above-described embodiment, the efficiency coefficient α used for calculation of the total enthalpy difference is the theoretical thermal efficiency of the Carnot cycle. However, the efficiency coefficient α is not limited thereto, and the efficiency coefficient α may be set to a value that is greater than 0 and less than the theoretical thermal efficiency in accordance with the specifications, etc., of the LSG for which calculation is performed.

In the above-described embodiment, the cold energy of liquefied natural gas is converted to mechanical energy for driving the primary expansion turbine of the primary power generation apparatus. However, the cold energy of liquefied natural gas is not required to be converted to mechanical energy. For example, the cold energy may be used as heat as is so as to cool a cold storage or may be converted to energy for producing liquefied carbon dioxide. In this case, the second enthalpy difference Δh2 may be defined without use of the efficiency coefficient α; i.e., as a value obtained by subtracting the specific enthalpy at the second point C2 from the specific enthalpy at the third point C3.

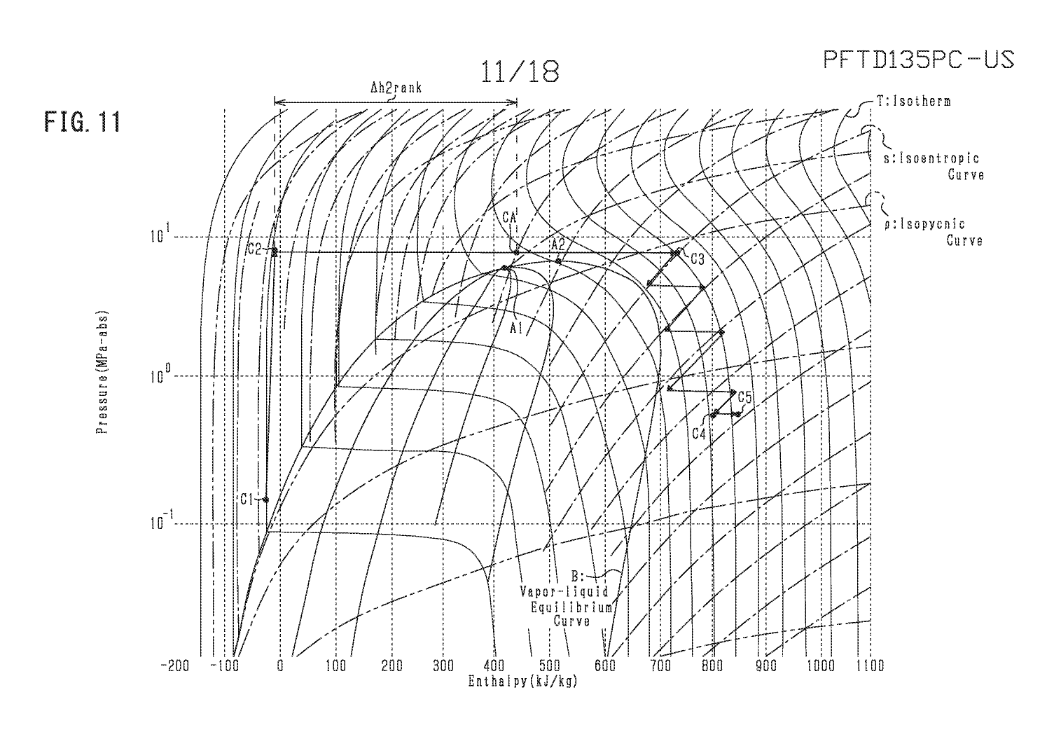

In the above-described embodiment, the second enthalpy difference is defined as a value obtained by subtracting the specific enthalpy at the second point C2 from the specific enthalpy at the third point C3. However, the second enthalpy difference is not limited to such a value, and may be defined as follows. As shown in FIG. 11, on the Mollier diagram, the state of natural gas at the outlet of the main vaporizer 15 is shown by an A point CA. The second enthalpy difference Δh2rank may be defined as a value obtained by subtracting the specific enthalpy at the second point C2 from the specific enthalpy at the A point CA. The total enthalpy difference Δhtotal in this case is represented by the following expression:

Δhtotal=α×Δh2rank+Δh3−Δh1 (4)

In this case, the efficiency coefficient α is defined as a value that is greater than 0 and equal to or less than the theoretical thermal efficiency of the Carnot cycle determined by the second temperature T2 at the second point C2 and the gas temperature at the A point CA. In the case where the working fluid of the Rankine cycle of the primary power generation apparatus is, for example, LPG (propane), the temperature at the A point CA is set to, for example, −44° C. The theoretical thermal efficiency of the Carnot cycle can be calculated as follows through use of the second temperature T2 (=−162° C.) at the second point C2 and the temperature TA (=−44° C.) at the A point CA.

$$\begin{matrix}α = 1 - T 2 / TA \\ = 1 - ( - 162 + 273.15 ) / ( - 44 + 273.15 ) \\ = 0.515\end{matrix}$$

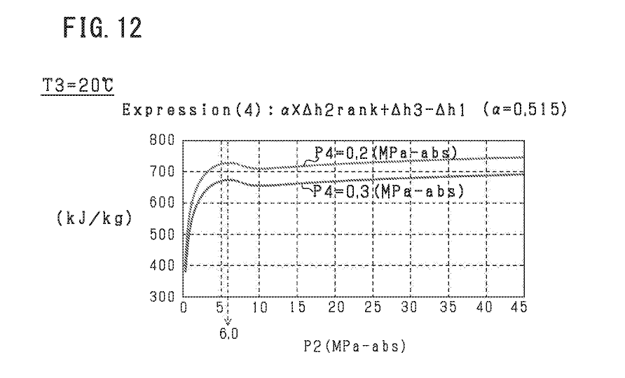

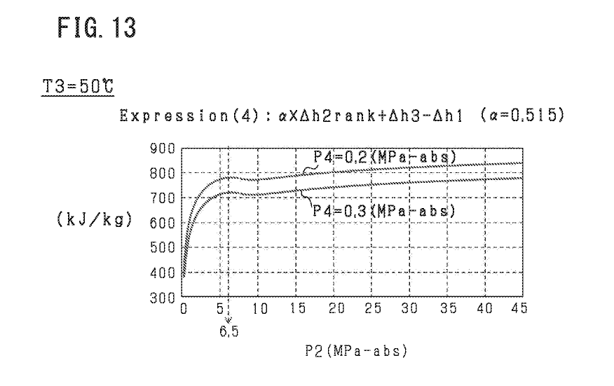

FIG. 12 shows the relation between the second pressure P2 and the total enthalpy difference Δhtotal that was calculated by substituting into the above-described expression (4) the first and third enthalpy differences Δh1 and Δh3 of the previously described FIGS. 4A and 4C for the case where the third temperature T3 is 20° C. and the second enthalpy difference Δh2rank. Also, FIG. 13 shows the relation between the second pressure P2 and the total enthalpy difference Δhtotal that was calculated by substituting into the above-described expression (4) the first and third enthalpy differences Δh1 and Δh3 of the previously described FIGS. 6A and 6C for the case where the third temperature T3 is 50° C. and the second enthalpy difference Δh2rank. Notably, the efficiency coefficients α in FIG. 12 and FIG. 13 were set to 0.515.

As shown in FIG. 12, in the case where the third temperature T3 is set to 20° C., irrespective of the fourth pressure P4, the second pressure P2 at which the total enthalpy difference Δhtotal of the above-described expression (4) first becomes the maximum when the second pressure P2 is increased from 0 was calculated as 6.0 MPa. Therefore, the pre-overboost pressure can be set to 6.0 MPa. Also, as shown in FIG. 13, in the case where the third temperature T3 is set to 50° C., irrespective of the fourth pressure P4, the second pressure P2 at which the total enthalpy difference Δhtotal of the above-described expression (4) first becomes the maximum when the second pressure P2 is increased from 0 was calculated as 6.5 MPa. Therefore, the pre-overboost pressure can be set to 6.5 MPa. FIG. 12 and FIG. 13 show an example in which the pre-overboost pressure is determined as a pressure lower than the critical pressure. However, depending on the gas composition, etc., the second pressure P2 at which the total enthalpy difference Δhtotal of the above-described expression (4) first becomes the maximum when the second pressure P2 is increased from 0 may be determined as a pressure equal to or higher than the critical pressure. Therefore, in the case where the pre-overboost pressure is determined through use of the above-described expression (4), the pre-overboost pressure may be determined as a pressure equal to or higher than the critical pressure.

Notably, as shown in FIGS. 12 and 13, when the second pressure P2 is increased from 0, the total enthalpy difference Δhtotal becomes the maximum. When the second pressure P2 is increased further, the total enthalpy difference Δhtotal decreases temporarily. However, after that, the total enthalpy difference Δhtotal increases constantly although the increase amount is small. Therefore, through employment of the method of setting to the pre-overboost pressure the second pressure P2 at which the total enthalpy difference Δhtotal first becomes the maximum when the second pressure P2 is increased from 0, the efficiency of conversion of cold exergy to electric power can be increased without excessively increasing the withstanding pressure required for, for examples, the equipment which constitutes the cold utilization system.

The determination of the pre-overboost pressure through use of the above-described expressions (1), (3), and (4) means the determination of the expansion turbine inlet pressure of the process (process from the third point C3 to the fourth point C4) that is the optimal condition for converting cold energy to electric power at the highest efficiency in the cold energy utilization process.

In the above-described embodiment, the primary generator of the primary turbine generator 18 and the secondary generator of the secondary turbine generator 20 are separate generators. However, the embodiment is not limited thereto. The primary and secondary turbine generators 18 and 20 may share a common generator.

In the above-described embodiment, the primary power generation apparatus is of a type in which a Rankine cycle is used. However, the primary power generation apparatus is not limited to the Rankine-cycle-type, and may be of a different type in which a vapor power cycle other than the Rankine cycle is used.

In the above-described embodiment, the second pressure P2 at which the total enthalpy difference Δhtotal becomes the maximum is set to the pre-overboost pressure. However, the second pressure P2 at which the total enthalpy difference Δhtotal assumes a value that is greater than 0 and less than its maximum value may be set to the pre-overboost pressure.

The low-temperature liquefied gas stored in the storage tank is not limited to liquefied natural gas, and may be, for example, liquefied petroleum gas, liquefied chlorofluorocarbon, or liquefied hydrogen.

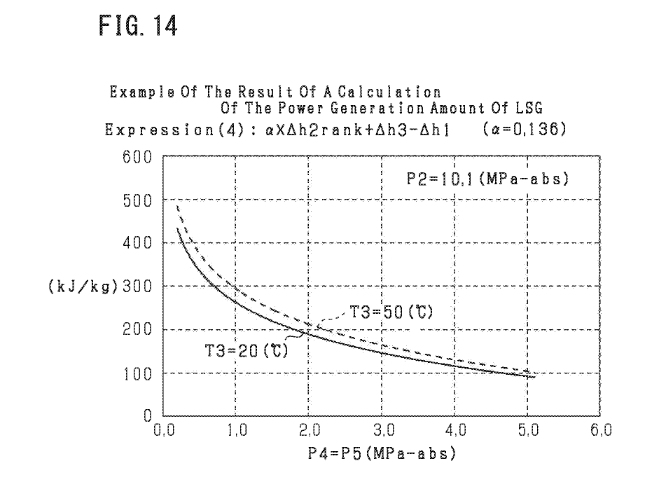

FIG. 14 shows an example of the result of a trial calculation of the power generation amount of LSG. Specifically, FIG. 14 shows an example of a trial calculation for determining the relation between the gas supply pressure (P4=P5) and power generation amount through use of the above-described expression (4) for the case where the second pressure P2 (pre-overboost pressure) was set to 10.1 MPa and the third temperature T3 was set to 20° C. or 50° C. Notably, in the trial calculation of FIG. 14, LPG was used as the working fluid (intermediate medium) of the Rankine cycle, and the efficiency coefficient α was set to 0.136.

Existing cold energy power generation systems assume that when a commercial power source from the outside such as a power company is lost, the operation is stopped. Therefore, at the time of stoppage of the commercial power source (power failure) or the like, existing cold energy power generation systems cannot generate electric power even though they are power generation systems.

In view of this, when the commercial power source is lost (at the time of power failure), through use of electric power of a different emergency power generator, power for control, seawater, and liquefied natural gas (specifically, liquefied natural gas from the secondary pump 12) are supplied to the cold energy power generation system (LSG) so as to preferentially start the LSG. The electric power generated by the LSG is supplied to other production plants within a factory together with in-house power by means of system interconnection, whereby the other production plants can be operated successively. Namely, the LSG functions as an “emergency power supply apparatus” in the case of emergency such as loss of the external commercial power source or power failure, and functions as a base load power source for the in-house power in the normal state.

Liquefied natural gas is manufactured by a natural gas liquefaction process at a gas production site in a foreign country through use of a large amount of electricity, and is then transported by a tanker. Since the LSG utilizes the natural gas and liquefaction electric power consumed at the production site, the LNG transport tanker transports “liquefied natural gas”+“liquefaction electric power.” Namely, the LSG is a system of efficiently recovering the cooling electric power (inexpensive electric power) used at the natural gas production site and utilizing it as electric power (expensive electric power) at a natural gas consumption site. Therefore, the LNG transport tanker has value as a “liquefied natural gas carrier” and an “electric power carrier,” and purchasing liquefied natural gas is the same as purchasing liquefied natural gas and production site electric power in combination. Therefore, by constituting an energy system that includes an LNG transport tanker and an LSG, there can be provided a business model in which the LNG transport tanker is used as a “liquefied natural gas carrier” and an “electric power carrier” (an electric power value chain between the upstream (production site) and downstream (consumption site) of LNG).

In a country to which liquefied natural gas is imported, the liquefied natural gas is stored in a storage tank. As a result of use of the LSG that efficiently extracts the cold energy of the liquefied natural gas, the storage tank becomes valuable as a “liquefied natural gas storage device” and an “electric power storage device.” Namely, when the cold energy of liquefied natural gas is efficiently recovered, the liquefied natural gas storage tank functions as an electric power storage device and contributes to leveling of peaks of electric power consumed during the daytime and the nighttime and improvement of electric power consumption rates in the daytime and the nighttime. Therefore, by constituting an energy system that includes a storage tank and an LSG, there can be provided a business model in which a storage tank storing liquefied natural gas is used as a “liquefied natural gas storage device” and an “electric power storage device.”

At a liquefied natural gas vaporization terminal, a company who imports liquefied natural gas can efficiently generate electric power by an LSG through utilization of the cold energy of the liquefied natural gas and can transfer the electric power by means of self consignment (consumption of electric power at a location other than the location of power generation becomes possible as a result of the revision of the Japanese Electricity Business Act), whereby the company can self-supply all the electric power used in facilities at all the operation areas of the company. Therefore, a business model of “zero emission business” can be provided. Also, by providing an energy system that includes an LSG and a liquefied natural gas liquefaction facility, it becomes possible to liquefy, through use of electric power generated in the nighttime, boil-off gas (BOG) produced as a result of vaporization of liquefied natural gas within a storage tank due to, for example, natural transfer of heat into the storage tank, generate electric power by the LSG in the daytime, and extract the generated electric power. Thus, it becomes possible to level the amounts of electric power consumed in the daytime and the nighttime. Therefore, a business model of “leveling peak electric powers in the daytime and the nighttime” can be provided.

What is claimed is:

1. A cold energy power generation system comprising:
a pressure-increasing pump that is configured to increase the pressure of a low-temperature liquefied gas stored in a storage tank to a pre-overboost pressure while maintaining the liquefied gas in a liquid state;
a primary power generation apparatus which includes a vaporizer that is configured to exchange heat between a predetermined cold exchange object and the liquefied gas whose pressure has been increased by the pressure-increasing pump, to thereby cool the cold exchange object and vaporize the liquefied gas, and which generates electric power through use of the cooled cold exchange object;
a heater for heating the vaporized gas flowing out of the vaporizer to thereby increase the temperature of the vaporized gas; and
a direct-expansion-type secondary power generation apparatus which includes a secondary turbine that is configured to be driven by the vaporized gas whose temperature has been increased by the heater and which generates electric power when the secondary turbine is driven,
the cold energy power generation system being characterized in that
on a Mollier diagram of a gas to be stored in the storage tank, an operating point that determines the pressure and the temperature of the gas in a state in which the gas is stored in the storage tank is defined as a process start point,
on the Mollier diagram, an operating point that determines the pre-overboost pressure and the temperature of the gas on the inlet side of the vaporizer is defined as a pre-overboost point,
on the Mollier diagram, an operating point that determines the pressure and the temperature of the gas on the inlet side of the secondary turbine is defined as a turbine inlet point,
on the Mollier diagram, the turbine inlet point or an operation point that determines the pressure and the temperature of the gas on the outlet side of the vaporizer and on the upstream side of the heater is defined as an intermediate point,
on the Mollier diagram, an operating point that determines the pressure and the temperature of the gas on the outlet side of the secondary turbine is defined as a turbine outlet point,
work which is performed by the pressure-increasing pump in a transition of the state of the gas from a state at the process start point to a state at the pre-overboost point on the Mollier diagram is defined as a first work (Δh1),
work which is performed by the primary power generation apparatus for power generation in a transition of the state of the gas from a state at the pre-overboost point to a state at the intermediate point on the Mollier diagram is defined as a second work (Δh2; Δh2rank),
work which is performed by the secondary turbine in a transition of the state of the gas from a state at the turbine inlet point to a state at the turbine outlet point on the Mollier diagram is defined as a third work (Δh3), and
the pre-overboost pressure is set on the basis of a value (Δhtotal) obtained by subtracting the first work from the sum of the second work and the third work.

2. A cold energy power generation system according to claim 1, wherein
the vaporizer is configured to exchange heat between a working fluid as the cold exchange object circulating through a vapor power cycle and the liquefied gas whose pressure has been increased by the pressure-increasing pump, to thereby condense the working fluid and vaporize the liquefied gas, and
the primary power generation apparatus is configured to generate electric power through use of the working fluid condensed in the vaporizer.

3. A cold energy power generation system according to claim 2, wherein
the primary power generation apparatus further includes a primary turbine that is configured to be driven by a gas produced by vaporizing the working fluid condensed in the vaporizer and to generate electric power when the primary turbine is driven, and
the second work is defined as work which is performed by the primary turbine in a transition of the state of the gas from the state at the pre-overboost point to the state at the intermediate point on the Mollier diagram.

4. A cold energy power generation system according to claim 3, wherein
the third work is defined as work which is performed by the secondary turbine when the state of the gas changes from the state at the turbine inlet point to the state at the turbine outlet point, such that the state of the gas does not enter a gas-liquid mixing phase on the Mollier diagram.

5. A cold energy power generation system according to claim 4, wherein
on the Mollier diagram, the turbine inlet point is defined as an operation point that determines the pressure and a predetermined temperature of the gas on the inlet side of the secondary turbine, and
the third work is defined as work which is performed by the secondary turbine as a result of performance of a multi-stage expansion in which adiabatic expansion of the gas by the secondary expansion turbine and re-heating of the adiabatic expanded gas to increase the temperature of the gas to the predetermined temperature in accordance with an isobaric change, the multi-stage expansion being performed in a transition of the state of the gas from the state at the turbine inlet point to the state at the turbine outlet point such that the state of the gas does not enter a gas-liquid mixing phase on the Mollier diagram.

6. A cold energy power generation system according to claim 1, wherein
the pre-overboost pressure is set to a pressure equal to or higher than the critical pressure of the liquefied gas, and
the vaporizer is configured to exchange heat between the working fluid and the liquefied gas whose pressure has been increased by the pressure-increasing pump, while maintaining the pressure of the liquefied gas at a pressure equal to or higher than the critical pressure, to thereby condense the working fluid and vaporize the liquefied gas.

7. A cold energy power generation system according to claim 6, wherein
the liquefied gas is a mixture of two or more types of gas compositions,
the pre-overboost pressure is set to a pressure equal to or higher than the cricondenbar of the liquefied gas, and
the vaporizer is configured to exchange heat between the liquefied gas and the working fluid, while maintaining the pressure of the liquefied gas at a pressure equal to or higher than the cricondenbar.

8. A cold energy power generation system according to claim 7, wherein
the liquefied gas is liquefied natural gas.

9. An energy system comprising:
a transport tanker for transporting liquefied gas; and
a cold energy power generation system according to claim 1.

10. An energy system comprising:
a storage tank for storing liquefied gas; and
a cold energy power generation system according to claim 1.

11. A method for utilizing a cold energy power generation system according to claim 1, wherein
the cold energy power generation system is utilized as a power supply source of a facility of a company that operates the cold energy power generation system.

12. A method for utilizing an energy system comprising:
a storage tank for storing liquefied gas; and
a cold energy power generation system according to claim 1, wherein
the energy system further comprises a facility for liquefying, through use of electric power generated in the nighttime, a boil-off gas produced as a result of vaporization of the liquefied gas within the storage tank and re-storing the liquefied boil-off gas in the storage tank as a liquefied gas.

13. A pressure setting method for setting a pre-overboost pressure of a cold energy power generation system comprising:
a pressure-increasing pump that is configured to increase the pressure of a low-temperature liquefied gas stored in a storage tank to a pre-overboost pressure while maintaining the liquefied gas in a liquid state;
a primary power generation apparatus which includes a vaporizer that is configured to exchange heat between a predetermined cold exchange object and the liquefied gas whose pressure has been increased by the pressure-increasing pump, to thereby cool the cold exchange object and vaporize the liquefied gas, and which generates electric power through use of the cooled cold exchange object;
a heater that is configured to heat the vaporized gas flowing out of the vaporizer to thereby increase the temperature of the vaporized gas, and
a direct-expansion-type secondary power generation apparatus which includes a secondary turbine that is configured to be driven by the vaporized gas whose temperature has been increased by the heater and which is configured to generate electric power when the secondary turbine is driven,
on a Mollier diagram of a gas to be stored in the storage tank, an operating point that determines the pressure and the temperature of the gas in a state in which the gas is stored in the storage tank is defined as a process start point,
on the Mollier diagram, an operating point that determines the pre-overboost pressure and the temperature of the gas on the inlet side of the vaporizer is defined as a pre-overboost point,
on the Mollier diagram, an operating point that determines the pressure and the temperature of the gas on the inlet side of the secondary turbine is defined as a turbine inlet point,
on the Mollier diagram, the turbine inlet point or an operation point that determines the pressure and the temperature of the gas on the outlet side of the vaporizer and on the upstream side of the heater is defined as an intermediate point,
on the Mollier diagram, an operating point that determines the pressure and the temperature of the gas on the outlet side of the secondary turbine is defined as a turbine outlet point,
the pressure setting method comprising the steps of:
calculating a first work (Δh1) which is work performed by the pressure-increasing pump in a transition of the state of the gas from a state at the process start point to a state at the pre-overboost point on the Mollier diagram;
calculating a second work (Δh2) which is work performed by the primary power generation apparatus for power generation in a transition of the state of the gas from a state at the pre-overboost point to a state at the intermediate point on the Mollier diagram;
calculating a third work (Δh3) which is work performed by the secondary turbine in a transition of the state of the gas from a state at the turbine inlet point to a state at the turbine outlet point on the Mollier diagram; and
setting the pre-overboost pressure on the basis of a value (Δhtotal) obtained by subtracting the calculated first work from the sum of the calculated second work and the calculated third work.

14. A pressure setting method according to claim 13, wherein:
the vaporizer is configured to exchange heat between a working fluid as the cold exchange object circulating through a vapor power cycle and the liquefied gas whose pressure has been increased by the pressure-increasing pump, to thereby condense the working fluid and vaporize the liquefied gas; and
the primary power generation apparatus is configured to generate electric power through use of the working fluid condensed in the vaporizer.
